(19) United States
(12) Patent Application Publication
(10) Pub. No.: US 2014/0380137 A1
(43) Pub. Date: Dec. 25, 2014

(54) APPARATUSES AND METHODS FOR WEB APPLICATION CONVERTER SYSTEMS

(71) Applicants: Haili Zhang, Shanghai (CN); Cong Liu, Shanghai (CN); Junyong Ding, Shanghai (CN); Jing Yong Zhu, Shanghai (CN)

(72) Inventors: Haili Zhang, Shanghai (CN); Cong Liu, Shanghai (CN); Junyong Ding, Shanghai (CN); Jing Yong Zhu, Shanghai (CN)

(21) Appl. No.: 13/995,345

(22) PCT Filed: Dec. 30, 2011
(86) PCT No.: PCT/CN11/85088

§ 371 Date: Nov. 15, 2013

(51) Int. Cl. G06F 17/22

(52) U.S. Cl. CPC G06F 17/227
USPC 715/202

(57) ABSTRACT

Systems and methods for converting web-based applications that were written for an original form-factor that supports a single operating system (OS) interface to multiple other form-factors and OS interfaces. A conversion process may be performed on applications that include HTML code, web scripts, CSS styles and various image or multimedia resources. Each file in a source application package is parsed for elements that may be modified based on a source profile and target profile for different device form-factors. Individual elements are resized, converted, or wrapped with a plug-in or shim, thereby accommodating the differences between different devices with different interfaces, screen resolutions and operating environments.

### BACKGROUND

User equipment (UE) may include computers, smart phones, laptops, set-top boxes, video game consoles, or other network enabled devices. UE and web technologies continue to evolve and expand in capabilities. For example with the increased use of Hypertext Markup Language v.5 (HTML5) traditional online web pages or applications are now available offline. Application developers may now package web applications with increasing degrees of complexity, from a simple search form to a shared calendar to a game to a full-blown productivity local application. For example, web applications in the form of W3C® (World Wide Web Consortium)/Web Access Control (WAC) widgets, hybrid web applications, Web OS applications, and the like may be used on a variety of UE, all with or without network or Internet access.

Generally, standalone applications are developed and designed for a single specific form-factor device such as a smart phone, a tablet, a personal computer (PC) or a television appliance, etc. that runs one specific operating system (OS) such as Android™, Tizen™, iOS®, or a Windows® platform. Even if a developer desires to provide an application that is targeted to multiple devices or platforms, the original development of an application is typically performed with a single environment or device as a target. The varying platform aspects, such as device resolution, multimedia format support, and runtime programming interfaces on individual devices, also add additional configuration variables that a developer may consider in application development for multiple platforms. Due to the various differences in platforms, creating one standalone web application that may work properly on multiple form-factor and OS runtime environments is a nearly impossible task.

For example, a W3C widget application that is designed for a touch screen based phone and targeted to run on both phone and TV would need to accommodate multiple display sizes. A developer would need to adjust any cascading style sheet (CSS) styles to fit a different screen resolution on TV, re-encode the videos that originally not supported by this TV and its underlying OS, and replace the touch screen based human computer interface (HCI) elements with a keyboard or remote control based HCI.

In an example scenario, when a developer wants to port a Windows® 8 Metro web application to a different OS platform, extra efforts will be involved in translating the Windows® WinRT application programming interface (API) into a different API standard (e.g., W3C). Regardless of the format or platform, a manual conversion from a first form factor to a second form factor involves the developer's time and efforts to adjust and fine-tune the user interface (e.g., HTML and/or CSS code), content resources (e.g., images, audio and video formats), and device specific APIs (e.g., W3C Device API, Windows® WinRT API) for each device and runtime environment.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram illustrating an example application conversion scenario, according to an embodiment.

FIG. 2 is a schematic diagram illustrating an example system for converting a source application package to two target application packages, according to an embodiment.

FIG. 3 is a schematic diagram illustrating an example of a converting a source application package into an all-in-one application package, according to an embodiment.

FIG. 4a illustrates an example device profile for storing device specific data, according to an embodiment.

FIG. 4b illustrates an example device profile with data for a tablet device, according to an embodiment.

FIG. 5 is a flowchart illustrating an example method for converting application style sheets, according to an embodiment.

FIG. 6 is a flowchart illustrating an example method for converting application style rules, according to an embodiment.

FIG. 7 is a flowchart illustrating an example method for converting image files, according to an embodiment.

FIG. 8 is a flowchart illustrating an example method for adapting functional resources between application environments, according to an embodiment.

FIG. 9 is a block diagram illustrating an example machine upon which one or more embodiments may be implemented.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Web application packages that may operate on various user equipment (UE), including mobile or smart devices, are referred to herein as a “standalone web application.”Standalone web applications may communicate over networks, for example the Internet, or without an active network connection after the application is loaded onto a UE. There is a need for tools and utilities that may help a developer easily create or port a standalone web application for use with multiple devices that may have various form-factors and different OS runtime environments.

In the present disclosure, the term “form factor” refers to a combination of size, design, and use of a device. Examples of form factors include, but are not limited to, a desktop machine, a mobile device, a tablet device, and a television appliance. A tablet device may be similar to a laptop, but where the laptop may be equipped with a permanently affixed physical keyboard, the tablet device may rely on a touchscreen interface. Thus, although the table and laptop devices are similar, and may be used for similar tasks, the form factors of each device is distinct based on the design of the hardware interface. Two similar devices with different screen sizes or resolutions, for example two tablet devices with identical operating systems but different sized display screens, may be considered to have separate and distinct form factors.

In the present disclosure, the terms “source profile” and “target profile” refers to a combination of information related to the form factor and operating system interfaces of a device. Examples of source and target profiles include, but are not limited to, device specific data stored in a table or database. Device data may include, but is not limited to, the resolution of a hardware display device in pixels, the diagonal size of the display device in inches or centimeters, a typical or optimal viewing distance in inches, and any other hardware specific information such as the availability of a camera, GPS receiver, removable media storage.

In order to port an application from one UE to a UE with a different form-factor or OS, developers may use device specific programming skills to modify the application on a device-by-device basis. Some UE may be limited by the feature set and availability of utility libraries. For example, developers may use an HTML5 feature detector library to determine which features may be available on a specific device. The developer may then carefully provide fallback routines for unsupported features. The developer may also refer to specific device application programming interface (API) frameworks in order to utilize the native capabilities of a UE, which may still be limited in specific OS runtime environments.

An application that is programmed to include a mobile user interface framework that relies on relative unit (e.g., a percentage size) to ensure all UI components extend properly for UE with different resolutions may assist a developer when porting the application between UE. However, when an application includes an absolute unit (e.g., a pixel dimension) to represent graphical elements on a UE, each graphical element may need to be resized in order to port the application from one UE to a second UE.

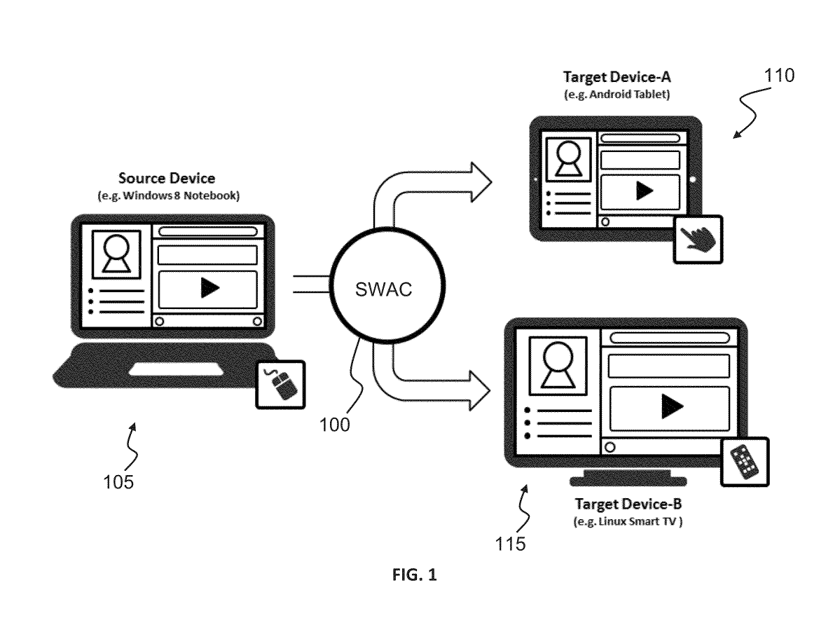

FIG. 1 is a schematic diagram illustrating an example application conversion scenario including a standalone web application converter (SWAC) 100. The SWAC 100 may assist developers by porting web applications from a source device 105 having a first form factor to devices with different form-factors or operating systems, such as a first target device-A 110 or a second target device-B 115. For example the source device 105 may be a notebook computer configured with an operating system (OS) such as Windows 8™. The first target device-A 110 or second target device-B 115 may include any of a variety of different form-factors (e.g. tablet, phone, PC, TV, etc.) or OS runtime environments (e.g. Android™, Tizen™, iOS™, etc.). In the example depicted in FIG. 1, the first target device-A 110 is a device with a tablet form-factor running a version of the Android™ operating system. The second target device-B 115 is a device with a television form-factor running a version of the Linux™ operating system.

The SWAC 100 may automatically convert an application between form factors with minimal manual intervention or reprogramming of an application for each target form-factor or OS. In an example, the SWAC 100 may convert a source application into two separate types of applications. A first conversion, referred to as a standalone conversion mode may convert a source application into multiple individual target application packages for an individual UE. A second conversion, referred to as an all-in-one conversion mode, may convert a source application into a single unified target application package that may include multiple resources that enable the target application to function on a variety of UEs.

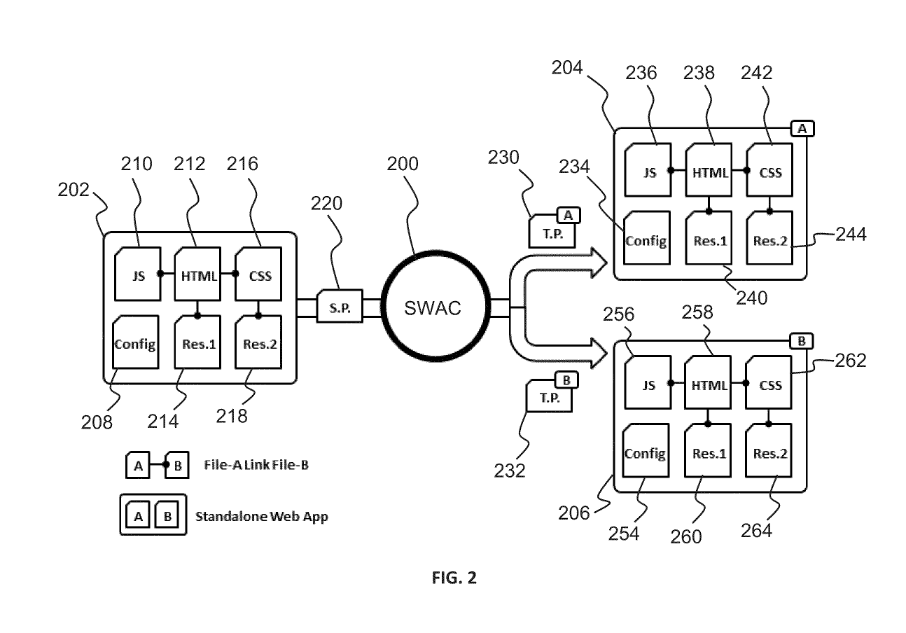

FIG. 2 is a schematic diagram illustrating a system for converting a source application package to two target application packages using a SWAC, in accordance with an example embodiment. The example SWAC 200 is configured to operate in the standalone conversion mode. In the standalone mode, a source application package 202, which is configured to operate on a first device type, may be converted into multiple standalone target application packages. After conversion of the source application package 202, a resulting first target application package 204 may operate with a second device type to provide the functionality included in the input source application package 202 on the second device type. A second target application package 206 may operate with a third device type to provide similar functionality. An unlimited number of target application packages, supporting any of a variety of device types, may be generated by SWAC 200 when provided with the appropriate configuration information, operating system interfaces, and device attributes.

An example source application package 202 may include, but is not limited to, a collection of source files and media resources that are designed and programmed to operate with a specific UE device. The source application package 202 may include a configuration file 208, one or more JavaScript code files 210, HTML files 212, HTML resource files 214, CSS data files 216, and CSS resources 218. The configuration file 208 may include information related to the operation of the application implemented by the source application package, such as user preferences for a specific form factor. The HTML files 212 contain the HTML code that defines the appearance of one or more pages or screens that are displayed to a user during the operation of the source application on a device. The HTML resource files 214 may include graphics images, icons, and audio or video media. CSS data 216 may include menu layouts, interface designs and the like. CSS resources 218 may include icons, pictures, graphics data, text, menu text/graphics and the like that may be utilized by the CSS data file 216.

The SWAC 200 may receive several data inputs in order to accomplish an application conversion. In addition to the source application package 202, a source profile (S.P.) 220 and one or more target profiles (T.P.) may be provided to the SWAC 200. Each source or target profile utilized by SWAC 200 may hold device related information in a device-profile file. Each profile utilized by SWAC 200 may also declare all Web API used in application and included in an application-profile file, for example JavaScript code files 210. Profiles may be constructed by third-party providers such as hardware device manufactures, operating system providers, or constructed by individual application developers.

A first target profile 230, which may correspond to Device-A 110, and second target profile 232, which may correspond to Device-B 115, may provide SWAC 200 with device related information in a device-profile file. The first target profile 230 may also define any necessary APIs included in the source application profile 210 in an application-profile file or data structure. Both device profile and application profile files are utilized by the SWAC 200 to convert a source application package 202 into one or more target application packages (204, 206).

The one or more target application packages (204, 206) (i.e., the output of SWAC 200) will maintain the original file organization and link relations between source files in the source application package 202, although the content of individual files may be changed during the conversion process. The generated target applications, in this example, first target application package 204 and second target application package 206, may run separately and independently on their respective target devices while providing the most or all of the functionality that was originally included in the source application package 202.

The first target application package 204 generated by the SWAC 200 may include a configuration file 234, one or more JavaScript code files 236, HTML files 238, HTML resource files 240, CSS data files 242, and CSS resources 244 that are modified to operate on the device described in the first target profile 230. Similarly, the second target application package 206 generated by the SWAC 200 may include a configuration file 254, one or more JavaScript code files 256, HTML files 258, HTML resource files 260, CSS data files 262, and CSS resources 264 that are modified to operate on the device described in the second target profile 232.

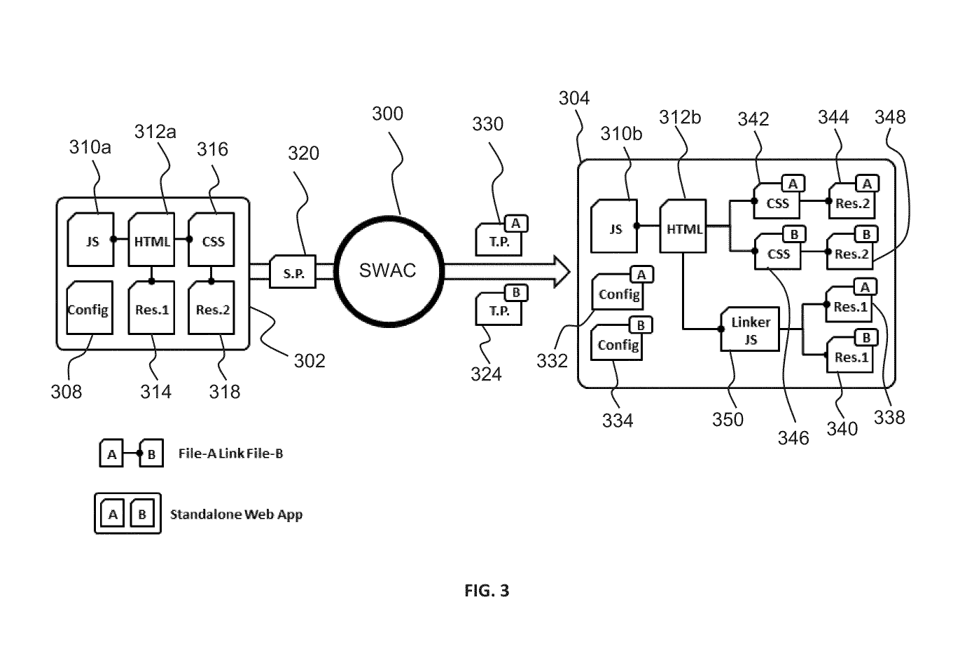

FIG. 3 is a schematic diagram illustrating an example of a converting a source application package into an all-in-one application package. An example of a SWAC 300 configured to operate in the all-in-one mode may generate a single target application package 304 that is capable of being executed on multiple devices, which may have different form factors or operating systems. Each of the resources in a source application package 302 is converted the same as in “standalone” mode discussed previously. The source application package 302 may include a configuration file 308, one or more JavaScript code files 310a, HTML files 312a, HTML resource files 314, CSS data files 316, and CSS resources 318.

The SWAC 300 may receive several data inputs in order to accomplish an all-in-one application conversion. In addition to the source application package 302, a source profile (S.P.) 320, and one or more target profiles (T.P.) may be provided to the SWAC 300. Each source or target profile utilized by SWAC 300 may include device related information in a device-profile file. Each profile utilized by SWAC 300 may also declare all APIs used in application and included in an application-profile file, for example JavaScript code files 310a.

A first target profile-A 330 may provided SWAC 300 with device related information in a device-profile file, and define any necessary APIs included in the source application profile 310 in an application-profile file. A second target profile-B 324 may provided SWAC 300 with device related information for a device with different form factor or operating system APIs. Both a device-profile and application-profile files are included in a source and target profiles and are utilized by the SWAC 300 to convert a source application package 302 into a target application package 304.

After the conversion, the single target application package 304 may have several versions of each resource file. For example, a configuration file 308 may be converted into multiple separate configuration files, one for each device type. A configuration file-A 332 and configuration file-B 334 may include data, information or options specific to their respective Device-A 110 and Device-B 115 formats. Similarly, a source CSS file 316 may be converted into separate versions as CSS-A file 342 and CSS-B file 346 that are each utilized for separate devices. A source CSS resource file 318 may be converted into separate CSS resource files Res.2-A 344 and Res.2-B 348 that are each utilized for separate devices (e.g., Device-A 110 and Device-B 115, respectively).

SWAC 300 may utilize device-aware resource linking to link multiple versions of resources to their respective HTML or CSS files without breaking the original relationships between the files. For example, a logical workflow of the source application may be controlled by script file 310a, for example a JavaScript™ compatible application that may direct the behavior or functionality of an application, may have links, references or relationships with HTML file 312a. This relationship is maintained in the resulting script file 310b which is linked to HTML file 312b. A script linking file 350 may be provided in the target application package 304 to provide a dynamic link to the separate HTML resource files Res.1-A 338 and Res.1-B 340. The generated target application 304 may run on all target devices (e.g., Device-A 110 and Device-B 115) while utilizing the resources necessary for operation on a specific device type.

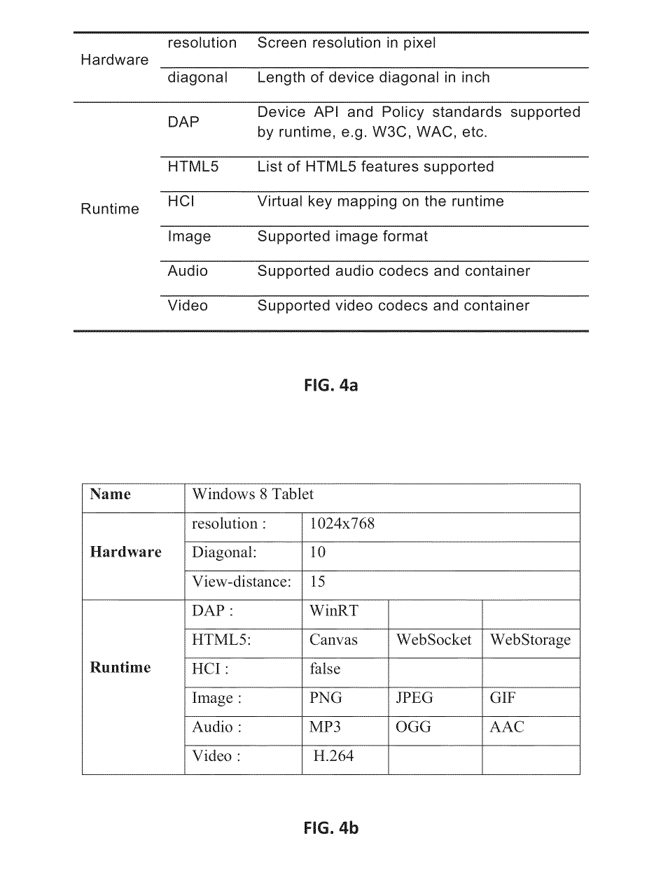

FIG. 4a illustrates an example device profile that includes device specific data stored in a table or database. Device data may include, but is not limited to, the resolution of a hardware display device in pixels, the diagonal size of the display device in inches or centimeters, a typical or optimal viewing distance in inches, and any other hardware specific information such as the availability of a camera, GPS receiver, removable media storage, etc. The API declaration format in an application profile may include various elements or data structures that indicate the runtime characteristics of the application. For example, a uniform resource identifier (URI) string may be used to identify each feature point.

An example application profile may include a list or array of features that are utilized by the application. Feature points may include, for example, geo-location services such as a GPS coordinates from a GPS receiver included in a device, the capability of importing or reading contacts from a user's contact database that is stored in memory or a file on a device, or a media-capture capability that may include obtaining still images or multi-frame videos from a camera included in a device.

FIG. 4b provides an example of device profile data that includes specific hardware device information and runtime parameters for an individual tablet device that in this example includes Windows 8 as its operating system. The example tablet has a display resolution of 1024 by 768 pixels and a diagonal screen distance of ten inches. The example tablet is typically viewed by a user at a distance of fifteen inches.

The example runtime environment supported by the tablet characterized in FIG. 4b includes a WinRT DAP, and support for the HTML5 canvas, websocket, and webstorage APIs. The example tablet does not support HCI. Image support includes the PNG, JPEG and GIF formats. Multimedia support includes the MP3, OGG and AAC audio formats and the H.264 video format.

In an example, a SWAC may include converter and adaptor components. A converter component receives content inputs, such as HTML or CSS data, and resources, such as image, audio, or video files that are included in a source web application. The converter modifies the inputs based on the information contained in the device profiles of both the source and target device, and generates output files that correspond to the data and resource inputs. An adaptor provides add-ons to fill and gaps in API functionality between the source and target devices. An adaptor receives input source files, along with both the device profile and application profile data, and generates a set of add-on files as outputs. The add-on files may be linked back to the content HTML files as polyfills (fallback functionality plugins), or plugged into specific web runtime modules as shims. An example of a shim is a software library or interface that may modify or translate parameters or messages in order to provide communication or functionality between different software components.

In an example embodiment, a SWAC tool may include four types of converters: a CSS converter, an image converter, a multimedia converter, and a configuration converter. Each converter may operate on a specific portion of a source application package in order to assemble a target application package.

A CSS converter converts CSS styles utilized by the applications and contained in the CSS files of the source application package. CSS styles that use absolute units (e.g., pixels), which may including font sizes, may be converted proportionally according to the screen resolution and physical size of origin and target devices. For HTML files, “style” attributes may be directly parsed, converted, and written to a target HTML file in a SWAC operating in Standalone Mode. Alternatively, the HTML “styles” may be extracted into a separated CSS file in All-in-1 Mode, and then a CSS converter may parse and convert the CSS file. After conversion the CSS file outputs may be linked back to a target HTML file as one or more external style sheets.

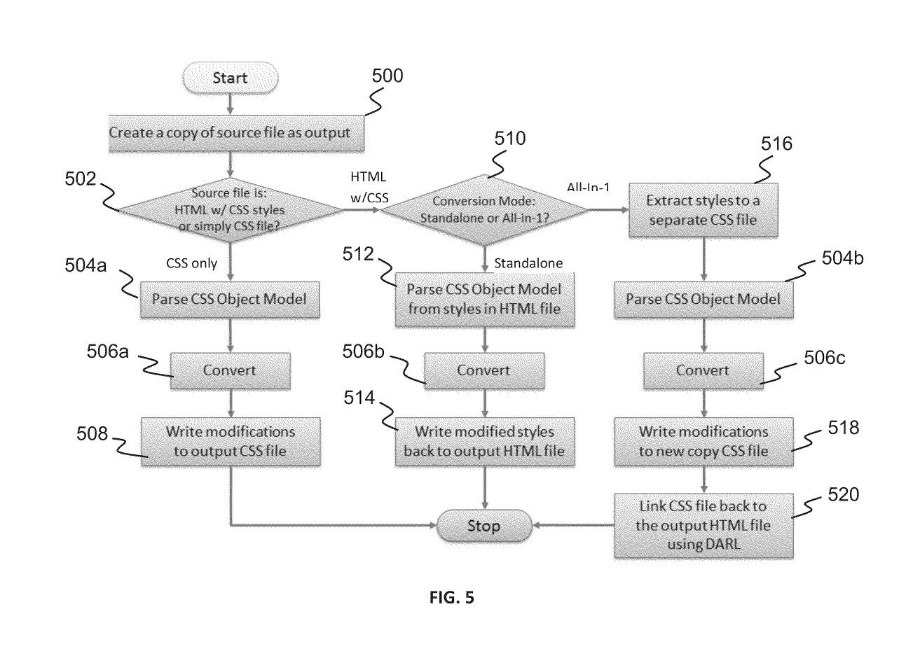

FIG. 5 illustrates an example of CSS conversion. At operation 500, a copy of a source application package is created that may serve as the target application package. At decision operation 502, the input source file is checked to determine if the source package includes HTML code with embedded CSS styles or only CSS files. If the source package only includes CSS style files, the CSS object model is parsed by parse operation 504a. CSS parsing may parse the literal style strings contained in a CSS file into a specific data model for further processing. In an example, the W3C CSS Object Model may provide a data model implementation. At convert operation 506a, the CSS data is converted and at write operation 508, the modified CSS data is written to a CSS file in the target application package.

If the decision operation 502 determines that the source package includes HTML code with CS Styles, decision operation 510 then determines if a SWAC is configured to operate in standalone or all-in-one mode. In Standalone Mode, parse operation 512 parses the CSS object model from styles included in the HTML files in the source application package. At convert operation 506b, the CSS data is converted and at write operation 514, the modified CSS styles are written back to the HTML file in the target application package.

If decision operation 510 determines that the SWAC is configured in all-in-one mode, at extract operation 516, the CSS styles in the HTML files are extracted and placed in a separate CSS file for inclusion in the target application package. At parse operation 504b, the CSS object model is parsed. At convert operation 506c, the CSS data is converted and at write operation 518, the modified CSS styles are written to the appropriate CSS file that was generated at extract operation 516 in the target application package. At link operation 520, a device-aware resource linker (DARL) may link the CSS files to the HTML file they were extracted from.

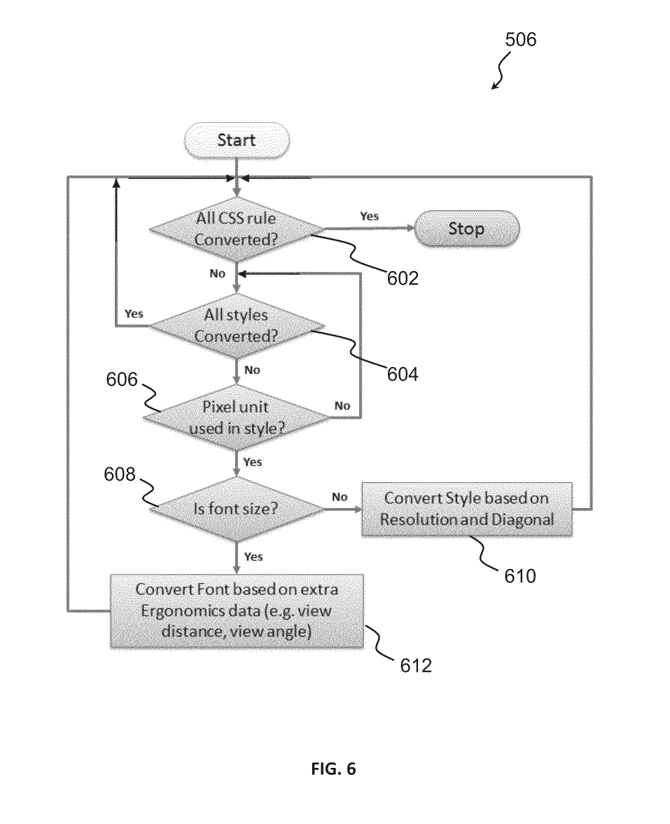

FIG. 6 is a flowchart illustrating an example method for converting application style rules, and illustrates the further details of the conversion operation 506 of FIG. 5. The conversion operation 506 may iterate through each CSS rule and style until conversion of the CSS data is complete. At operation 602, the conversion operation 506 checks to determine if all CSS rules are converted. If there are no unconverted rules, then at operation 604, a check is performed to determine if all styles are converted. If all styles and rules are converted the conversion operation 506 is complete.

Except for font sizes, styles using pixel units may be enlarged or shrunk proportionally to accommodate any difference in the resolution and diagonal size of the source and target devices. At operation 606 a check is performed to determine if pixels are utilized as a unit in a style. If there are pixel units remaining, at operation 608 a check is performed to determine if the pixel unit is related to a font size. At operation 610, the CSS styles, other than font sizes, are converted by adjusting the size of the styles in proportion to any change in resolution and diagonal size between the source device and the target devices, as indicated in the device profile data that is provided to a SWAC.

At operation 612, the font sizes included in the CSS are converted. The font size conversion process may adjust the size of the fonts in proportion to any change in resolution and diagonal size between the source device and the target devices, and also include ergonomics related empirical data, such as differences in viewing distance and viewing angle between the source and target devices, when adjusting the size of text fonts. For example, a tablet device may have a relatively short viewing distance of several inches (e.g. 12-20 inches), while a television form factor may have a similar device resolution but a much larger diagonal size and long viewing distance of multiple feet (e.g., 2-20 feet). Due to the increased diagonal size and longer viewing distance the converter 506 may increase the font size more than would be required for a tablet to tablet form factor conversion in order to ensure that a user will be able to read any text that is displayed with the font.

In an example SWAC, an image converter optimizes the size of all image files in a source application package. If the target device has smaller resolution than the source device, then the image may be resized proportionally. If the target device has a higher resolution than the source device, which exceeds a predefined threshold for acceptable image viewing, the SWAC may notify the developer to provide a high definition image in order to accommodate larger resolution device and avoid an unacceptable degradation in image quality.

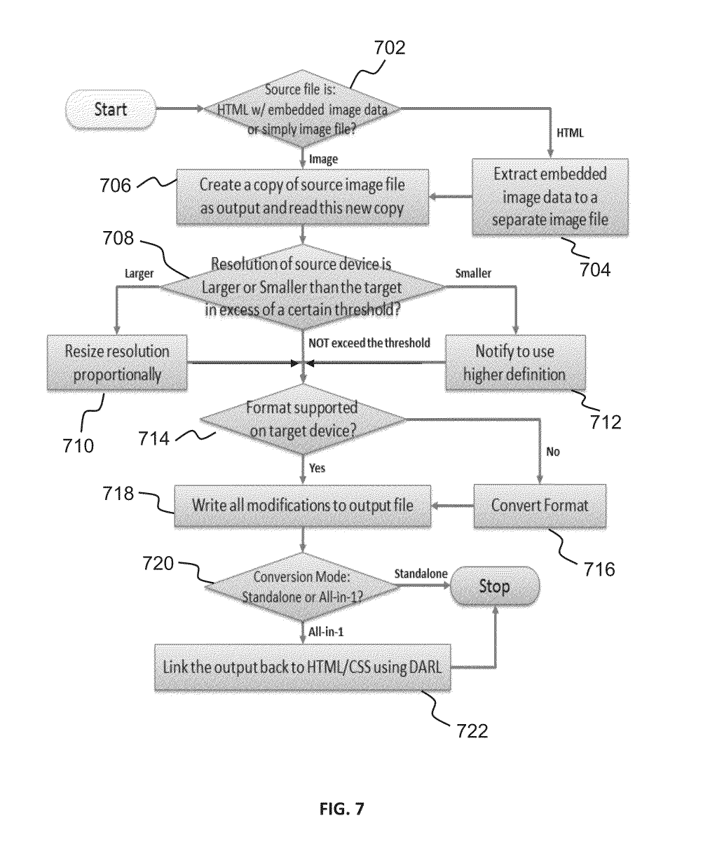

FIG. 7 illustrates an example of the processing flow of an example conversion method. At operation 702, the image converter determines if the source application includes separate image files or image data embedded in HTML or CSS files. The location of image data may be determined using a Data-URI mechanism that may parse the HTML or CSS files. At operation 704, any image data that is embedded in a HTML or CSS file is extracted and placed in a separate image file. At operation 706, all image files, either separately contained in the source application package or extracted from a CSS or HTML file are copied for use in the target application package. The separated image files will be processed by following an image conversion flow.

At check operation 708, the source device has a larger or smaller resolution than the target device. If the source device has a higher resolution than the target device, each image is resized proportionally at operation 710. If the image cannot be resized proportionally, in which case the target resolution exceeds a predefined threshold for acceptable image viewing, at operation 712 the SWAC may notify the developer to provide a high definition image in order to accommodate larger resolution device and avoid an unacceptable degradation in image quality. If the source images are within an acceptable size threshold, even if the target device is of a higher resolution than the source device, an image may be used without resizing.

At operation 714, a check is performed to determine if each image format included in the source application package is supported on the target device. If an image format is not supported on the target device, at operation 716 a conversion operation is performed to convert an image into a supported format, (e.g. GIF to JPEG). At operation 718, all modified image files are written into the target application package.

At operation 720, a check is performed to determine if the SWAC is operating in all-in-one or standalone mode. If the SWAC is in standalone mode the image conversion process is complete. If the SWAC is operating in all-in-one mode, at operation 722, a static link between each image file and its corresponding HTML or CSS file may be created to allow the HTML or CSS files to access the appropriate image files for each supported device type.

In an example, a multimedia converter adjusts the quality and re-encodes any audio or video resources in a source application package to include a bitrate and codecs that are compatible with the target device. A multimedia converter may also optimize the video resolution of the resources for the target device.

The multimedia conversion process may follow a process that is similar to the image converter process illustrated in FIG. 7. The multimedia conversion process may differ in that multimedia files may use different size identifiers. For example, where an image is typically measured by pixel count resolution, an audio file may be measured in bit rates or sampling frequency. Video content may include both resolution and bit rate or sample frequency measures. Similarly, for audio or video data embedded in HTML files a multimedia converter may apply a similar extraction process as that used by the image converter illustrated in FIG. 7.

For applications that include on-line streaming audio or video (e.g., a real time streaming protocol (RTSP), etc.) a multimedia converter may notify the developer to check or verify potential quality and codec compatibility issues between the source and target devices. A notification may be provided by the SWAC when the HTML parser detects a hard-coded reference to on-line audio or video resources.

In an example, a configuration converter converts configuration files into a format that is compatible with the target device. A configuration converter may be applicable for a widget package conversion. For example, converting an Apple® Dashboard or Nokia® Symbian™ Web Runtime (WRT) widget to W3C or WAC Widget format.

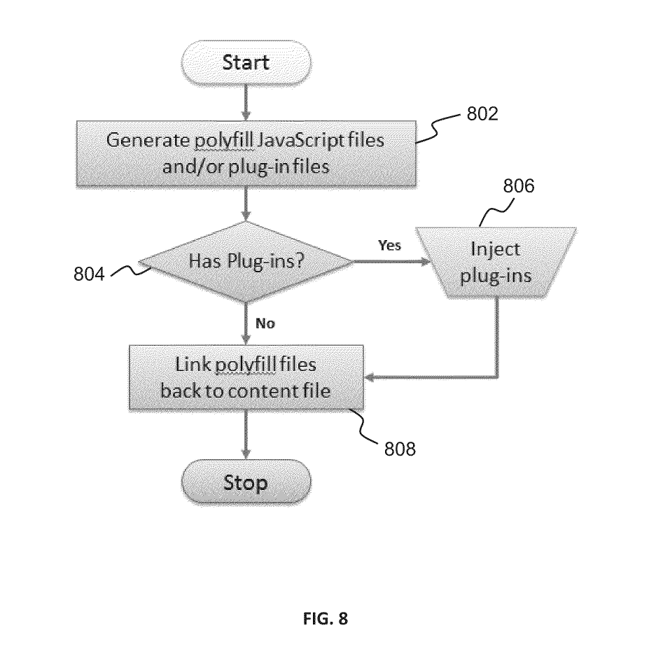

In one example, a SWAC tool may include three kinds of adaptors: an HCI adaptor, an HTML5 API adaptor, and a device API adaptor. FIG. 8 is a flowchart illustrating an example of adaptor operation. An adaptor may provide add-ons to fill any functionality gaps between the operating system APIs in the source and target devices. At operation 802, an adaptor takes in source code files along with both device and application profiles for the source and target devices, and generates a set of add-on files that may be linked back to the content HTML files as polyfills (fallback functionalities) or plugged into specific web runtime as shims. At operation 802, a SWAC determines if an application includes plug-ins. If plug-ins are included in the source application package, at operation 806, updated plug-ins are injected into the target package based on the API provided by the target operating system. At operation 808, the SWAC may link the polyfills or plug-ins back to the appropriate HTML or content files in the target application package.

An example HCI adaptor provides essential human-interaction related libraries (e.g. gesture, keyboard) as fallbacks for target devices. For example an HCI adaptor may generate a keyboard control HCI library when porting app onto TV form-factor, or a gesture library for devices that require a runtime API in a specific OS that does not natively support a gesture API.

An example HTML5 API Adaptor may provide shims, fallbacks, and polyfills in order to implant HTML5 functionality in application runtime code that are not natively supported. For example, an HTML5 API adaptor may generate application form elements fallbacks for Android™ based web applications that were developed in a different operating system such as iOS™.

An example device API Adaptor may provide shims for runtime code for target devices that do not provide a desired device API, or wrappers for APIs that support other specifications. For example, wrappers of WAC APIs for target device from W3C Device API spec used in the source.

An all-in-one web application requires all resources, each of which has multiple versions of target devices, embedded or linked to the original application. Device-aware resource linking (DARL) is a technique that links all resources into an all-in-one web application statically or dynamically so that the application may run using corresponding resources on current device. For example, in an application that supports three devices: devA, devB and devC, and includes three sets of resources resA, resB and resC, the resources are each linked to the application files in the all-in-one application. At run time, the all-in-one application may indicate which set of resources is to be used by the application based on the device type. Specifically, resA is only used on devA, and likewise for resB on devB and resC on devC.

During the operation of a SWAC, separate static or dynamic approaches may be utilized to provide device-aware recourse linking A media query may be utilized to determine the device's width and height and use corresponding CSS resources. A dynamic link may be utilized to determine which resources are linked into the application.

A media query may help to determine the device's width and height and use corresponding CSS resources. For example the use of multiple <link> tags with different “media” attributes for each kind of device, or the use of multiple “@media” references combined with an “@import” within a single CSS resource or inline <style> tag may indicated how resources are to be used for individual devices. TABLE 1 provides an example of static linking to resources in an application that does not utilize a script.

```
TABLE 1
<link type=“text/css” rel=“stylesheet” media=“(media for dA)” href=“rA”/>
  <link type=“text/css” rel=“stylesheet” media=“(media for dB)”
  href=“rB”/>
  <link type=“text/css” rel=“stylesheet” media=“(media for dC)”
  href=“rC”/>
  Or
  <link type=“text/css” rel=“stylesheet” href=“all-in-one.css”/>
  Contents of “all-in-one.css”:
  @media (media for dA) { @import “rA”; }
  @media (media for dB) { @import “rB”; }
  @media (media for dC) { @import “rC”; }
  Or
  <style type=“text/css”>
  @media (media for dA) { @import “rA”; }
@media (media for dB) { @import “rB”; }
  @media (media for dC) { @import “rC”; }
  </style>
```

TABLE 2 illustrates and example of multiple “<source>” tags to indicate audio or video resources are supported for devices that support different decoders. In this example, a SWAC may insert multiple <source> tags, each of which has its own “src” attribute pointed to an audio or video resource for one specific codec.

```
TABLE 2
<video>
  <source src=“rA” type=“video/mp4” codec=“avc1.42E01E, mp4a.40.2”/>
  <source src=“rB” type=“video/ogg” codec=“theora, vorbis”/>
  <source src=“rC” type=“video/webm” codec=“vp8, vorbis”/>
</video>
```

A dynamic link may indicate which resources are linked into the application by the script. The general procedure of dynamic link is to first detect and identify the device and OS runtime environment before the resources are loaded. When the device and OS are determined the linker may replace the resource with a correct version by modifying the “src” attribute of <img>, <audio>, <video>, and <source> tags as shown in the examples depicted in TABLE 1 and TABLE 2.

A SWAC may utilize one or more methods to identify the current device. A SWAC may interrogate “user agent”: check the browser's navigator.userAgent to find out the type of the device. Alternatively, the SWAC may query a mediaMatch or size related attribute. The use of mediaMatch with a media query statement in static link may be utilized to determine the type of the device. For example, the device-width and device-height attributes may be compared to device profile information to match the devices that have the same resolutions.

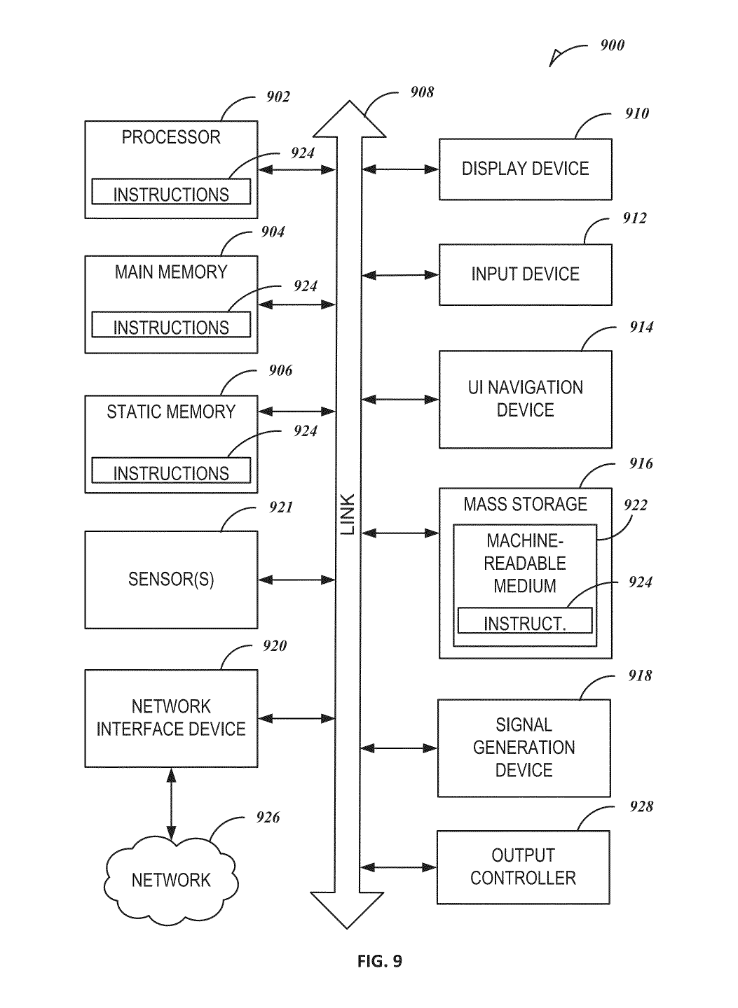

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via a link 908 (e.g., a bus, link, interconnect, or the like). The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a mass storage (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR)) connection to communicate or control one or more peripheral devices (e.g., a printer, card reader, etc.).

The storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine-readable media.

While the machine-readable medium 922 is illustrated as a single medium, the term “machine readable medium” may include a single medium or multiple media (e.g., a centralized or distributed database, and/or associated caches and servers) that configured to store the one or more instructions 924.

The term “machine-readable medium” may include any tangible medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### ADDITIONAL NOTES & EXAMPLES

Example 1 includes subject matter (such as a tangible machine or computer-readable medium having computer executable instructions that, when executed on a computing device, cause the computing device to perform a method, etc.) including at least one machine readable medium comprising a plurality of instructions that in response to being executed on a computing device, cause the computing device to: receive a first application package, the first application package configured to support a first form-factor corresponding to a first computing device; access a source profile corresponding to the first computing device; access a target profile corresponding to a second computing device, the second computing device having a second form-factor; and generate a target application package, configured to support the second form-factor corresponding to the second computing device, by copying and modifying the first application package.

In Example 2, the subject matter of Example 1 may optionally include instructions that in response to being executed on a computing device, cause the computing device to: extract style information from the first application package; and modify the style information in response to a difference between the first form-factor and the second form-factor.

In Example 3, the subject matter of Examples 1 or 2, wherein the style information includes a cascading style sheet (CSS).

In Example 4, the subject matter of Examples 1, 2, or 3, wherein the cascading style sheet (CSS) is embedded in a hyper text markup language (HTML) file.

In Example 5, the subject matter of Examples 1, 2, 3, or 4, may optionally include instructions that in response to being executed on a computing device, cause the computing device to: extract at least one resource file from the first application package; and modify the at least one resource file in response to a difference between the first form-factor and the second form-factor.

In Example 6, the subject matter of Examples 1, 2, 3, 4, or 5, wherein the at least one resource file is selected from a group consisting of: an image file, an audio file, and a video file.

In Example 7, the subject matter of Examples 1, 2, 3, 4, 5, or 6 may optionally include instructions that in response to being executed on a computing device, cause the computing device to: receive a second target profile corresponding to a third computing device, the third computing device having a third form-factor; wherein the target application package is configured to support both the second form-factor corresponding to the second computing device and the third form-factor corresponding to the third computing device.

In Example 8, the subject matter of Examples 1, 2, 3, 4, 5, 6, or 7 may optionally include instructions that in response to being executed on a computing device, cause the computing device to: dynamically link the target application package with a first resource corresponding to the second form-factor and a second resource corresponding to the third form-factor.

In Example 9, the subject matter of Examples 1, 2, 3, 4, 5, 6, 7, or 8 wherein the at least first resource and the second resource are selected from a group consisting of: an image file, an audio file, and a video file.

Example 10 includes subject matter (such as a method, a system, an apparatus, a device, etc.) comprising: accessing a source profile corresponding to a first computing device; accessing a target profile corresponding to a second computing device; and converting a first standalone web application, including a first form-factor corresponding to the first computing device, to a second standalone web application including a second form-factor corresponding to the second digital computing device.

In Example 11, the subject matter of Example 10 may optionally include converting a first interface format included in the first form-factor to a second interface format included in the second form-factor.

In Example 12, the subject matter of Examples 10 or 11, wherein the interface format includes a cascading style sheet (CSS).

In Example 13, the subject matter of Examples 10, 11, or 12 may optionally include converting an image from a first size included in the first form-factor to a second size included in the second form-factor.

In Example 14, the subject matter of Examples 10, 11, 12 or 13 may optionally include extracting an image file from a hyper text markup language (HTML) file.

In Example 15, the subject matter of Examples 10, 11, 12, 13, or 14 may optionally include converting a first audio format included in the first form-factor to a second audio format included in the second form-factor.

In Example 16, the subject matter of Examples 10, 11, 12, 13, 14, or 15 may optionally include converting a first video format included in the first form-factor to a second video format included in the second form-factor.

In Example 17, the subject matter of Examples 10, 11, 12, 13, 14, 15, or 16 wherein the source profile includes an application profile and a device profile; and the target profile includes an application profile and a device profile.

Example 18 includes subject matter (such as a system, an apparatus, a device, etc.) comprising: a device database, stored on a tangible computer readable medium, including a plurality of device profiles, the plurality of device profiles included at least one source device profile corresponding to a first form-factor, and at least one target device profile corresponding to a second form-factor; and a standalone web application converter configured to execute on a processor linked to the tangible computer readable medium; wherein the standalone web application converter is configured to receive a source application package, the source application package configured to support a first form-factor corresponding to a source computing device and including a plurality of resources corresponding to the first form-factor; wherein the standalone web application converter is configured to write a target application package to a computer readable medium in response to receiving the source application package.

In Example 19, the subject matter of Example 18, wherein the plurality of resources is selected from a group consisting of: an image file, an audio file, and a video file.

In Example 20, the subject matter of Examples 18 or 19, wherein the at least one source device profile includes a first application profile, and the target device profile includes a second application profile.

In Example 21, the subject matter of Examples 18, 19, or 20, wherein the standalone web application converter is configured to convert a first interface format included in the first form-factor to a second interface format included in the second form-factor.

In Example 22, the subject matter of Examples 18, 19, 20, or 21, wherein the interface format includes a cascading style sheet (CSS).

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. At least one machine readable medium comprising a plurality of instructions that in response to being executed on a computing device, cause the computing device to:
receive a first application package, the first application package configured to support a first form-factor corresponding to a first computing device;
access a source profile corresponding to the first computing device;
access a target profile corresponding to a second computing device, the second computing device having a second form-factor; and
generate a target application package, configured to support the second form-factor corresponding to the second computing device, by copying and modifying the first application package.

2. The machine readable medium as recited in claim 1, comprising instructions that in response to being executed on a computing device, cause the computing device to:
extract style information from the first application package; and
modify the style information in response to a difference between the first form-factor and the second form-factor.

3. The machine readable medium as recited in claim 2, wherein the style information includes a cascading style sheet (CSS).

4. The machine readable medium as recited in claim 3, wherein the cascading style sheet (CSS) is embedded in a hyper text markup language (HTML) file.

5. The machine readable medium as recited in claim 1, comprising instructions that in response to being executed on a computing device, cause the computing device to:
extract at least one resource file from the first application package; and
modify the at least one resource file in response to a difference between the first form-factor and the second form-factor.

6. The machine readable medium as recited in claim 5, wherein the at least one resource file is selected from a group consisting of: an image file, an audio file, and a video file.

7. The machine readable medium as recited in claim 1, further comprising instructions that in response to being executed on a computing device, cause the computing device to:
receive a second target profile corresponding to a third computing device, the third computing device having a third form-factor;
wherein the target application package is configured to support both the second form-factor corresponding to the second computing device and the third form-factor corresponding to the third computing device.

8. The machine readable medium as recited in claim 7, instructions that in response to being executed on a computing device, cause the computing device to:
dynamically link the target application package with a first resource corresponding to the second form-factor and a second resource corresponding to the third form-factor.

9. The machine readable medium as recited in claim 8, wherein the at least first resource and the second resource are selected from a group consisting of: an image file, an audio file, and a video file.

10. An application conversion method comprising:
accessing a source profile corresponding to a first computing device;
accessing a target profile corresponding to a second computing device; and
converting a first standalone web application, including a first form-factor corresponding to the first computing device, to a second standalone web application including a second form-factor corresponding to the second digital computing device.

11. The method of claim 10, further comprising: converting a first interface format included in the first form-factor to a second interface format included in the second form-factor.

12. The method of claim 11, wherein the interface format includes a cascading style sheet (CSS).

13. The method of claim 10, further comprising: converting an image from a first size included in the first form-factor to a second size included in the second form-factor.

14. The method of claim 13 comprising: extracting an image file from a hyper text markup language (HTML) file.

15. The method of claim 10, further comprising: converting a first audio format included in the first form-factor to a second audio format included in the second form-factor.

16. The method of claim 10, further comprising: converting a first video format included in the first form-factor to a second video format included in the second form-factor.

17. The method of claim 10, wherein the source profile includes an application profile and a device profile; and the target profile includes an application profile and a device profile.

18. A system to convert applications to support multiple formats comprising:
a device database, stored on a tangible computer readable medium, including a plurality of device profiles, the plurality of device profiles included at least one source device profile corresponding to a first form-factor, and at least one target device profile corresponding to a second form-factor; and
a standalone web application converter configured to execute on a processor linked to the tangible computer readable medium;
wherein the standalone web application converter is configured to receive a source application package, the source application package configured to support a first form-factor corresponding to a source computing device and including a plurality of resources corresponding to the first form-factor;
wherein the standalone web application converter is configured to write a target application package to a computer readable medium in response to receiving the source application package.

19. The system of claim 18, wherein the plurality of resources is selected from a group consisting of: an image file, an audio file, and a video file.

20. The system of claim 18 wherein the at least one source device profile includes a first application profile, and the target device profile includes a second application profile.

21. The system of claim 18, wherein the standalone web application converter is configured to convert a first interface format included in the first form-factor to a second interface format included in the second form-factor.

22. The system of claim 21, wherein the interface format includes a cascading style sheet (CSS).
